(19) United States
(12) Patent Application Publication
(10) Pub. No.: US 2009/0017422 A1
(43) Pub. Date: Jan. 15, 2009

(54) METHOD, SYSTEM, AND APPARATUS FOR DENTAL APPLIANCE WITH ACTIVE INGREDIENTS FOR MULTIPLE APPLICATIONS

(76) Inventor: Alan Austin Creamer, Carlsbad, CA (US)

Correspondence Address: Richman and Associates, PO Box 3333, La Jolla, CA, 92038-3333, US

(21) Appl. No.: 12/173,016

(22) Filed: Jul. 14, 2008

Related U.S. Application Data
(60) Provisional application No. 60/959,357, filed on Jul. 13, 2007.

(51) Int. Cl. A61C 19/06

(52) U.S. Cl. 433/215

(57) ABSTRACT

Embodiments of teeth and related gum cell treatment are described generally herein. Other embodiments may be described and claimed.

### CROSS REFERENCE TO RELATED APPLICATIONS

The present application claims the benefit of priority to U.S. Provisional Application No. 60/959,357, entitled “Dual Mouth Piece for Whitening, Protection, Delivering Medications That is Formed Without Heat,” filed on Jul. 13, 2007, the entirety of which is incorporated by reference.

### TECHNICAL FIELD

Various embodiments described herein relate generally to treating teeth and related gum tissue, including systems, and methods used in treating teeth and related gum tissue.

### BACKGROUND INFORMATION

It may be desirable to treat teeth and related gum tissue, the present invention provides such treatment.

### BRIEF DESCRIPTION OF THE DRAWINGS

FIG. 1A is a simplified top, partial isometric diagram of a teeth and related gum treatment system according to various embodiments.

FIG. 1B is a simplified diagram of the treatment system of FIG. 1A including an inner section according to various embodiments.

FIG. 1C is a simplified left side diagram of the treatment system of FIG. 1A according to various embodiments.

FIG. 1D is a simplified back diagram of the treatment system of FIG. 1B according to various embodiments.

FIG. 1E is a simplified top diagram of the treatment system of FIG. 1B according to various embodiments.

FIG. 1F is a simplified side isometric diagram of the treatment system of FIG. 1B according to various embodiments.

FIG. 1G is a simplified top diagram of the treatment system of FIG. 1A including an inner section according to various embodiments.

FIG. 1H is a simplified side isometric diagram of the treatment system of FIG. 1B including an implanted lighting system according to various embodiments.

FIG. 1I is a simplified top isometric diagram of the treatment system of FIG. 1A including an implanted lighting system according to various embodiments.

FIG. 2A is a simplified diagram of cross sectional diagram of an inner section according to various embodiments.

FIG. 2B is a simplified diagram of cross sectional diagram of an inner section including implanted lighting coupled to a light generation system according to various embodiments.

FIG. 2C is a simplified diagram of cross sectional diagram of an inner section including implanted lighting coupled to a light generation system according to various embodiments.

FIG. 2C is a simplified diagram of cross sectional diagram of an inner section including implanted lighting coupled to a light generation system according to various embodiments.

FIG. 2D is a simplified diagram of cross sectional diagram of an inner section including implanted lighting coupled to a light generation system according to various embodiments.

FIG. 3A-4 are diagrams of signals that may be applied to one or more teeth and related gum treatment systems according to various embodiments.

FIG. 5A-5C are flow diagrams illustrating teeth and related gum treatment system processing algorithms according to various embodiments.

FIG. 6 is a block diagram of an article according to various embodiments.

### DETAILED DESCRIPTION

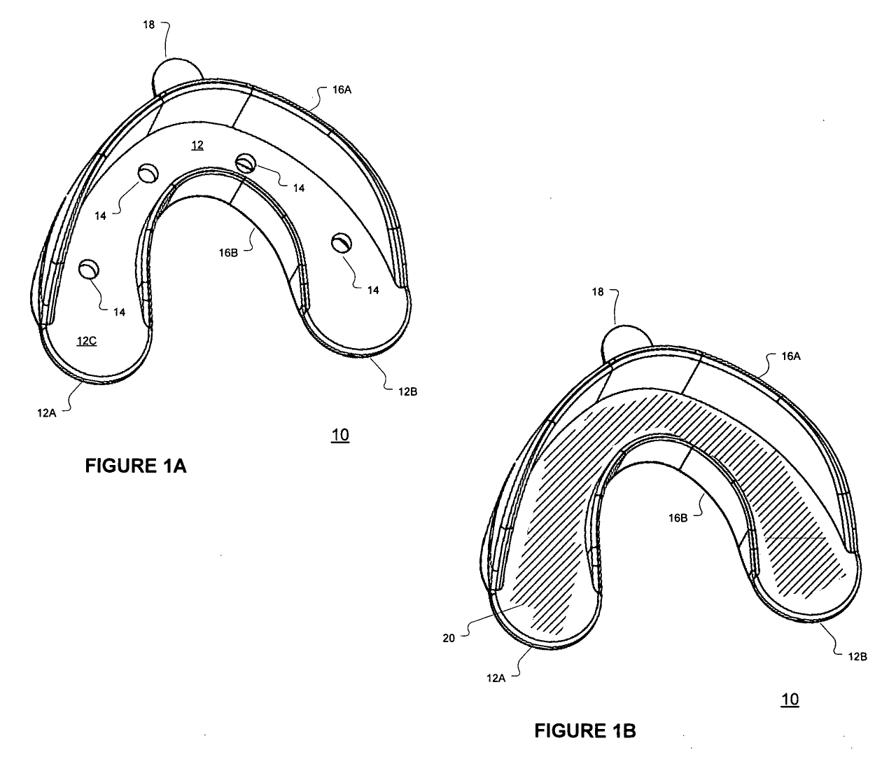

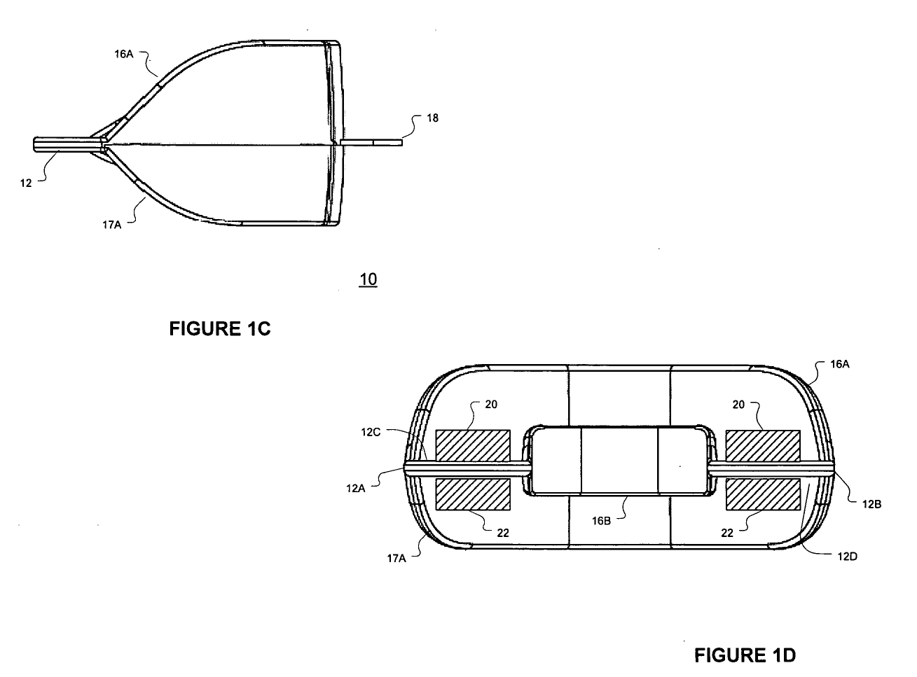

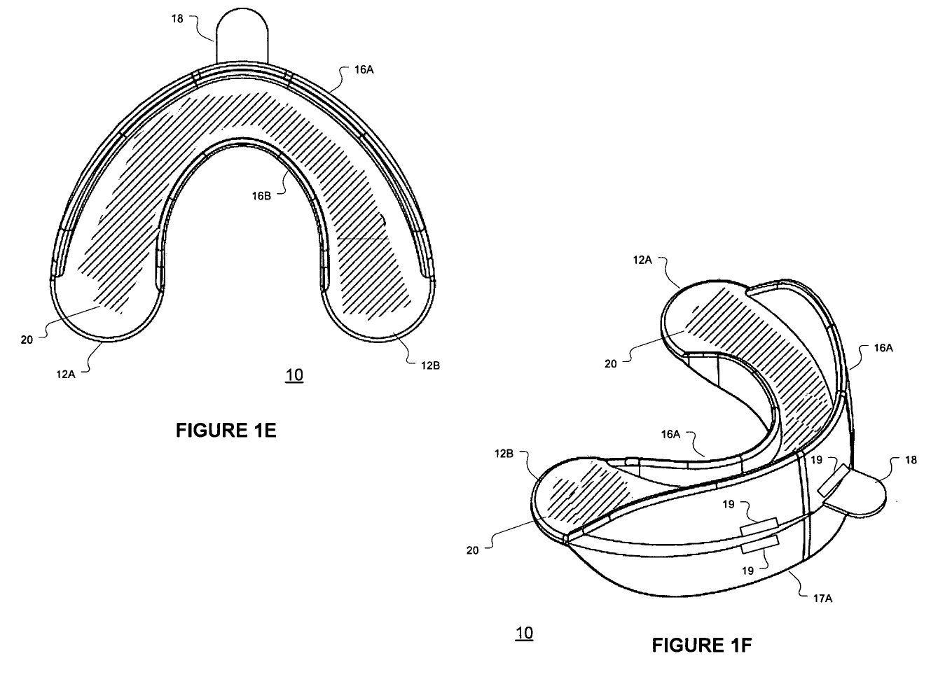

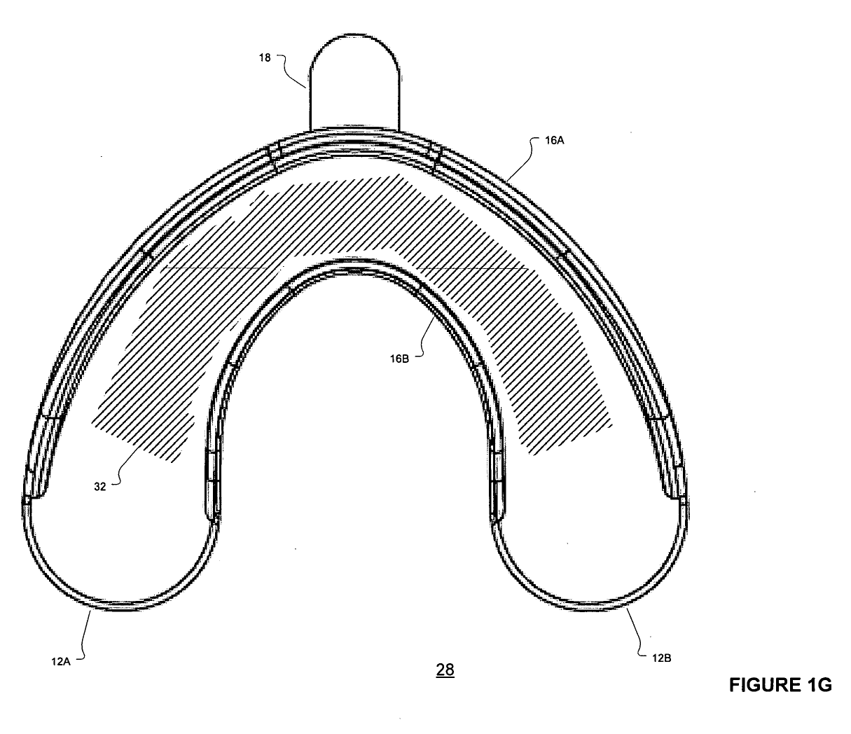

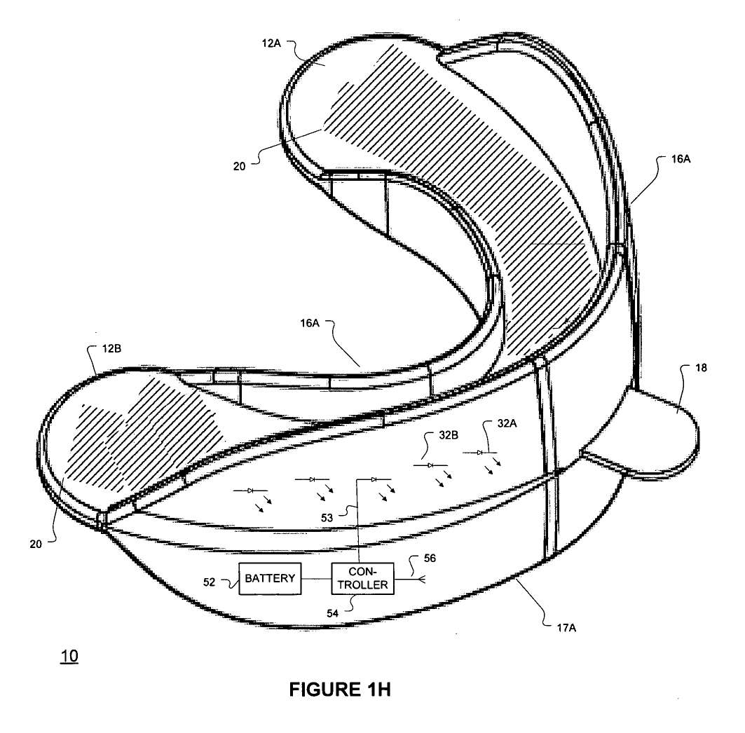

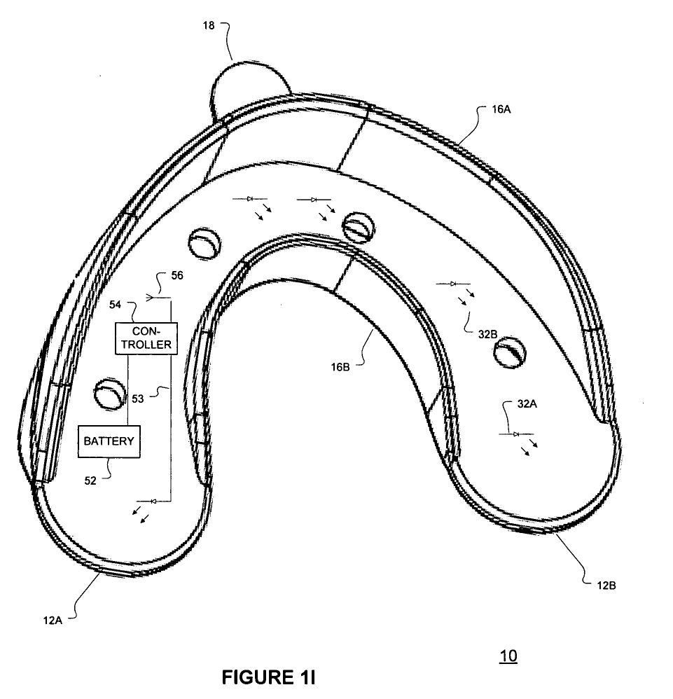

FIG. 1A is a simplified top, partial isometric diagram of a teeth and related gum treatment system 10 according to various embodiments. In an embodiment the system 10 is a dental tray 10 including a center section 12, labial (lip) guard or shield 16A, lingual (tongue) guard or shield 16B, and tab 18. The center section or divider 12 may include a plurality of holes 14, a left wing 12A, and a right wing 12B. FIG. 1B is a simplified diagram of the treatment system of FIG. 1A including an inner section 20 according to various embodiments. The treatment system 10 may be worn as a protective entity ad as part of a treatment regimen where a user's teeth may be engaged to the inner section 20 of the top side 12C of the divider 12 and the inner section 21 on the bottom side 12D of the divider 12.

The treatment system 10 may be configured to fit over or engage one or both arches of a user's teeth. The divider or center section 12 may have a curved or “U” shape from a top profile. The system 10 may be configured as a single arch, where the horizontal cross section would resemble the letter “U” for an upper arch and an inverted “U” for a lower arch. As shown in FIG. 1A to FIG. 1I, the system 10 may be configured to fit over both teeth arches simultaneously. Accordingly the system 10 may have the shape of the capital letter “I” as shown in FIG. 1C.

In an embodiment the system 10 the divider 12, the labial guard 16A, and the lingual guard 16B may include a soft or pliable material such as silicon, nylon, or flexible plastic. The divider 12, the labial guard 16A, and the lingual guard 16B may be light permeable or transparent. Further the divider 12, the labial guard 16A, and the lingual guard 16B may be formed from a single material. The inner section 20 may be formed from a second material. The divider 12, the labial guard 16A, and the lingual guard may be integrally formed or may be fused together so as to form a single continuous layer.

Further the divider 12, the labial guard 16A, the lingual guard 16B, and the inner section 20 may be formed from a single material. The divider 12, the labial guard 16A, the lingual guard 16B, and the inner section 20 may be integrally formed or may be fused together so as to form a single continuous layer or outer section. The inner section 20 may be relatively soft and able to conform to the shape of teeth when worn or engaged. In an embodiment the outer section (the divider 12, the labial guard 16A, the lingual guard 16B) may be less compliant than the inner section to maintain the general shape of the tray in use.

The system 10 may be configured to enable dentition of upper and lower teeth arches simultaneously. The system 10 may be configured as part of a teeth or gum treatment modality. The system may include light sources 32A, 32B, 332 such as FIG. 1H, 1I, 2B, 2C, 2D that may enable irradiation of the dentition (teeth and gums) while the system 10 is deployed in a user's mouth. As shown in FIG. 1H, 1I, 2B, 2C, 2D, the light sources may be embedded in one of the divider 12, the labial guard 16A, the lingual guard 16B. The divider 12 may be a clear or transparent layer that separates the upper and lower arches, 16A, 16B.

The divider layer 12 may enable light to pass from the labial side 16A toward the lingual side 16B of the system 10. The divider may be have varying thickness to vary the amount of light able to propagate there through. The divider 12 may be able 1 to 3 mm thick in an embodiment. The divider may have a wedge or modified wedge shape which may catch and disperse light in an optimal pattern. The divider 12 may be composed of a material different than the rest of the tray. The divider 12 optical qualities, such as clarity or refractive index may be correlated to the rigidity or deformability of the material.

In an embodiment, the inner section 20, 21 may include a deformable silicon putty-like material, wax, or a foam materials such as memory foam. The inner section 20, 21 material volume may be sufficient to deform in use to closely conform to the outer shape of teeth when teeth are inserted into inner section 20, 21 volume. The inner section 20, 21 may keep its shape when teeth were inserted and removed thereafter. The inner section 20, 21 may retain a teeth impression inside the inner section 20, 21 volume for a period of time.

In an embodiment The system 10 may be easily attached to a lighting source. As shown in FIG. 1H, 1I, 2B, 2C, 2D, a light source may be an integral part of the system 10 such as LEDs 32A, 32B, or other sources of light 332, or can be a separate unit with a section of the tray designed to match with the light source. A light source may not be placed in contact with the tray, but light may irradiate directly on the surface of the tray and through it to the teeth.

The inner section 20 may be employed to apply therapy to teeth or gums. The inner section 20 may have several layers 20A, 20B, 20C where the layers may be have different flexibility and may contain one or more chemicals that are activated by light, water, and other forces when in operation. For example, the system 10 may be employed to visually whiten a user's teeth. In such an embodiment a whitening agent may be employed in one or more layers 20A, 20B, 20C of the inner section (20, 21). In another embodiment, a whitening agent may be placed in the intaglio of teeth when removed from a users mouth and thereafter placed in contact with the same teeth/gums to apply therapy to them. As noted, the inner section 20, 21 may form a negative impression of teeth when the teeth are pressed into the section 20, 21. In an embodiment teeth may be withdrawn from the tray easily where the inner section 20, 21 does not adhere to the teeth.

A thin treatment layer may be effectively applied to teeth or gums via the system 10. In a method, the system 10 may be placed into the mouth. A user may bites gently into the inner section 20, 21 until they reach a stop. At that point, the inner section 20, 21 may have conformed to teeth, gum surfaces. The system 10 may then be removed leaving a negative impression of the teeth/gums pushed into the inner section 20 of the system 10. The inner section 20 intaglio may be loaded or coated with a thin layer of some treatment agent such as a peroxide containing gel and placed back into the mouth. A small treatment agent volume may be comfortably held in intimate contact with teeth/gum surface to increase treatment effectiveness while minimizing total body dosage. In an embodiment the system 10 may be rocked slightly back and forth before removal to create a slight void between the inner tray material and teeth/gums, permitting larger dosage of treatment agents.

For tooth whitening applications, the agents may include dry hydrogen peroxide precursors such as calcium percarbonate impregnated into an inner layer 20B of the inner section 20. When a user bites into the inner section 20, a peroxide precursor may be spread onto the surface of the inner section 20 where a user's saliva may initiate the breakdown of the calcium percarbonate into active hydrogen peroxide. Other agents may include calcium peroxide, sodium percarbonate, sodium perborate, alkali metal peroxides, alkali metal percarbonates, and alkali metal perborates.

Other agents such as amino acids and amino acid oxidases (such as proline, alanine, methionine, leucine, glutamic acid, glutamine, aspartic acid, phenylalanine, cysteine, lysine, histidine, asparagines, serine, tyrosine, cystine, arginine, tryptophane, glycine, or hydroxyproline) may be employed to accelerate a teeth/gum bleaching effect in combination with a peroxide gel in the inner section 20. Another accelerators may be employed. The inner layer 20B may include these chemicals and the layer 20A may be coated with an accelerator including pH adjusters such as sodium hydroxide, ammonium hydroxide, tris amino (Angus Chemical), AMPD (Angus Chemical) and sodium tripoly phosphate, copper gluconate, magnesium gluconate, manganese gluconate, tyrosine, cystine, arginine, tryptophane, glycine, or hydroxyproline.

Other treatment agents may include fluoride, coloring agents, antibacterials, desensitizers and other hard tissue treatment agents. The system 10 may also be used to deliver dosages of soft tissue treatments including vitamin D and E, aloe vera, antibacterials, emollients and other treatment agents. The systems 10 may also be used as a quick method of taking impressions of dentition, which may then be used in as an impressions, such as to create plaster casts of the teeth as a diagnostic tool. In addition, the system may be used as a protective device against fracture and displacement of teeth during sports or other activities. The inner section 20 may absorb greater shock and force compared to a conventional stiff or hard device. Traditionally it has been necessary to heat up a standard mouthguard in extremely hot water in order to get the tray to mold to the teeth. The system 10 may include one or more airways 10 that may enable a user to wear the system 10 while sleeping. The system 10 may hold a user's jaws in a proper alignment during sleep to possibly reduce snoring and reduce sleep apnea.

As shown in the figures, the system 10 may include a plurality of embedded LEDs 32A, 32B, a battery 52, a controller 54, and an antenna 56. In an embodiment the LED 32A may be configured to emit energy of a first particular frequency range and the LED 32B may be configured to emit energy of a second particular frequency range. The surface 22 may be embedded with a chemical 22A that may be used to treat teeth and related gum cells. The chemical 22A may be reactive to the first and the second frequency ranges. Further teeth and related gum cells may be reactive to the first and the second frequency ranges. In addition, the combination of the chemical 22A and the application of the first and the second frequency ranges to the chemical 22A and teeth and related gum cells may have a synergetic effect.

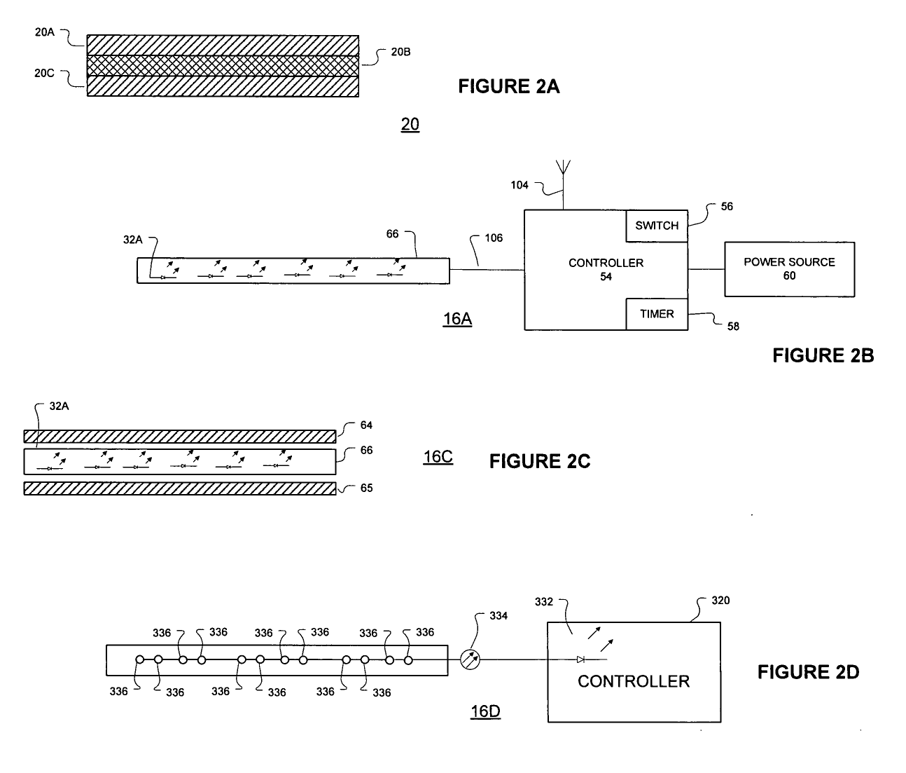

In an embodiment the chemical 22A may be applied directly to the teeth and related gum cells to be treated. In a further embodiment a chemical 22A may not be employed in addition to the system 10. The teeth and related gum treatment system 10 may include a single translucent layer 66 such as shown in FIG. 2C. The layer 66 may include one or more light emitting diodes (LED) 32A, 32B embedded in the layer, and a second translucent or opaque layer 65. The layer 66 may be comprised of a polyurethane, medical silicon, or other pliable, translucent, hypoallergenic material.

In an embodiment a local controller 54 and battery 52 may also be embedded in one the layers 66, 12, 16A, 16B. The controller 54 may be electrically coupled to the one or more LEDS 32A, 32B. The controller 54 may also be coupled to a battery 52. The controller 54 may generate one or more signals for LEDs 32A, 32B as a function of a user switch 56. The signals may vary as a function of the first and second frequency ranges. The controller 54 may include one or more timers 58 that may limit the application of energy to the LEDs 32A, 32B to predetermined time intervals. In an embodiment the controller may also be coupled to an antenna 56 to receive or transmit one or more signals related to the transmission of energy to one or more LEDs 32A, 32B. As shown in FIG. 1G the system 28 may be configured to treat a particular segment of teeth and related gum cells. The system 10 is configured to conform to a user's anatomy so that emitted light is focused on teeth and related gum cells.

FIG. 2D is a simplified diagram of a teeth and related gum treatment system layer 16D according to various embodiments. In the layer 16D the controller 320 may include LED lens 336, a fiber optic pathway 334, an LED 332. In this embodiment the LED 332 may be coupled to lens 336 via the fiber optic pathway 334. The controller 320 may generate an LED signal via the LED 332 that is transmitted to teeth and related gum cells via the lens 336 and the fiber optic pathway 334.

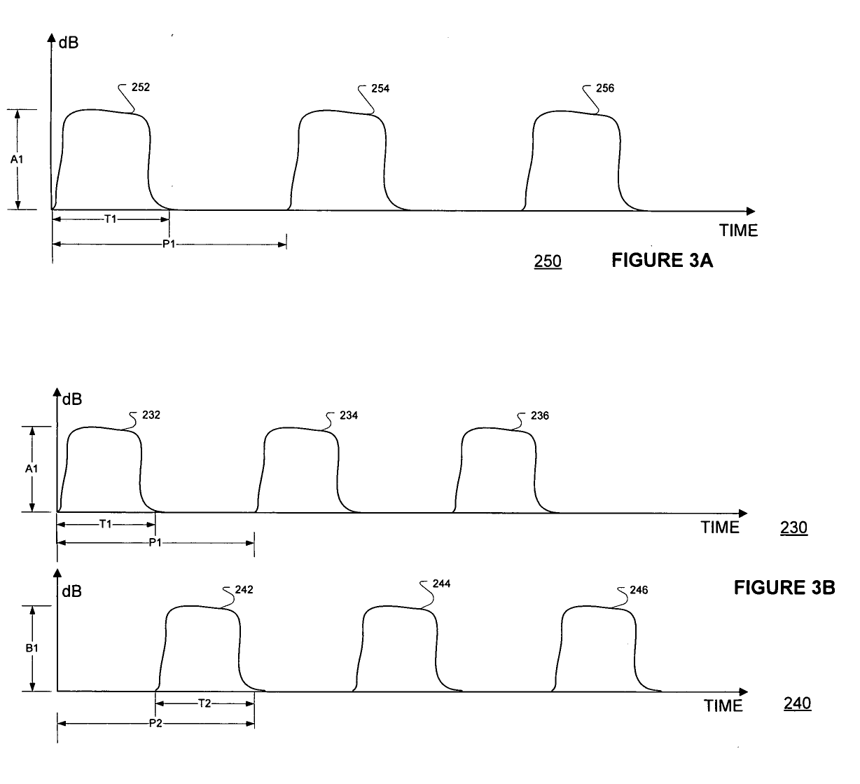

FIGS. 3A-3B are diagrams of electrical signal waveforms 230, 240, 250 that may be applied to one or more LEDs 32A, 32B, 332 according to various embodiments. The signal waveform 250 includes several square-wave pulses 252, 254, 256 that may be applied to an LED 32A, 32B, 332. Each pulse 252, 254, 256 may a have a similar magnitude and envelope. The waveform 250 may be used to energize an LED 32A, 32B, 332 periodically P1 for a predetermined interval T1 where each pulse 252, 254, 256 has a amplitude A1. In an embodiment, A1 may be about 0.1 milliamperes (mA) to 10 mA, the pulse width T1 may be about 100 microsecond (μs) to 500 μs and the period P1 may from 100 ms to 500 ms as a function of the energy required to create capacitance in a liquid. In another embodiment, A1 may be about 0.5 milliamperes (mA) to 5 mA, the pulse width T1 may be about 200 microsecond (μs) and the period P1 may about 250 ms as a function of the energy to create capacitance in a liquid.

In FIG. 3B a signal waveform 230 may be applied to a first LED 32A, 32B, 332 module or group and a second waveform 240 may be applied or used to energize a second LED 32A, 32B, 332 module. The signal waveform 230 includes several square-wave pulses 232, 234, and 236 and the signal waveform 240 includes several square-wave pulses 242, 244, and 246. Each pulse 232, 234, 236, 242, 244, 246 may a have a similar magnitude and envelope. The waveform 230 may be used to energize a first LED 32A, 32B, 332 module periodically P1 for a predetermined interval T1 where each pulse 232, 234, 236 has an amplitude A1. The waveform 240 may be used to energize a second LED 32A, 32B, 332 module periodically P2 for a predetermined interval T2 where each pulse 242, 244, 246 has an amplitude B1. The pulse width T1, T2 may be about 100 microsecond (μs) to 500 μs and the period P1, P2 may from 100 ms to 500 ms as a function of the energy to affect teeth and related gum cells or chemicals 22A. In another embodiment, A1, A2 may be about 0.5 milliamperes (mA) to 5 mA, the pulse width T1, T2 may be about 200 microsecond (μs) and the period P1, P2 may about 250 ms as a function of the energy required to affect teeth and related gum cells or chemicals 22A. In an embodiment the pulses 232, 234, 236 do not substantially overlap the pulses 242, 244, 246. In an embodiment T1>T2 and P2 is an integer multiple of P1.

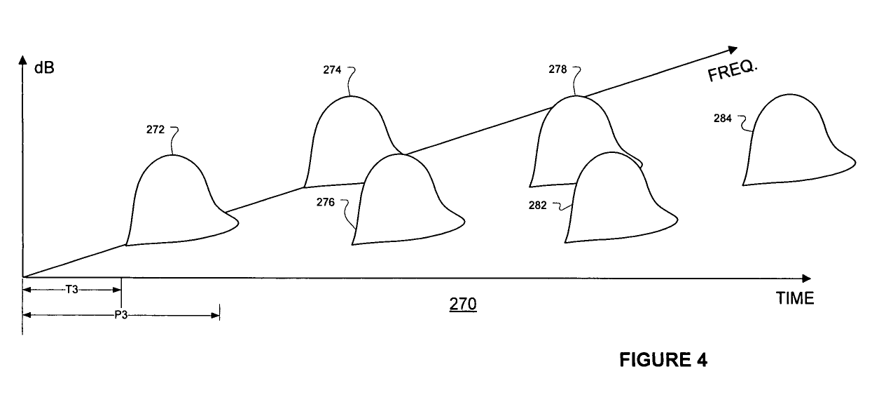

FIG. 4 depicts a waveform 270 that includes multiple pulses 272, 274, 276, 278, 282, and 284 that may not overlap in the time or the frequency domain. In an embodiment each pulse 272, 274, 276, 278, 282, and 284 may have a pulse width T3, and frequency spectrum width F1 and period P3. The pulse 272 is frequency offset from the pulse 274, the pulse 276 is frequency offset from the pulse 278, and the pulse 282 is frequency offset from the pulse 284. The pulses 272, 274, 276, 278, 282, and 284 may be applied to an LED module to affect teeth and related gum cells or chemicals 22A. Pulses 272, 274 having different frequency spectrums may enable different LED stimulation. In an embodiment the pulses 272, 276, 282 may be applied to a first LED module and the pulses 274, 278, 284 may be applied to a second LED module. The frequency separation between the respective pulses may enable simultaneous energization of a first and a second LED module and subsequent and independent spectrum generation.

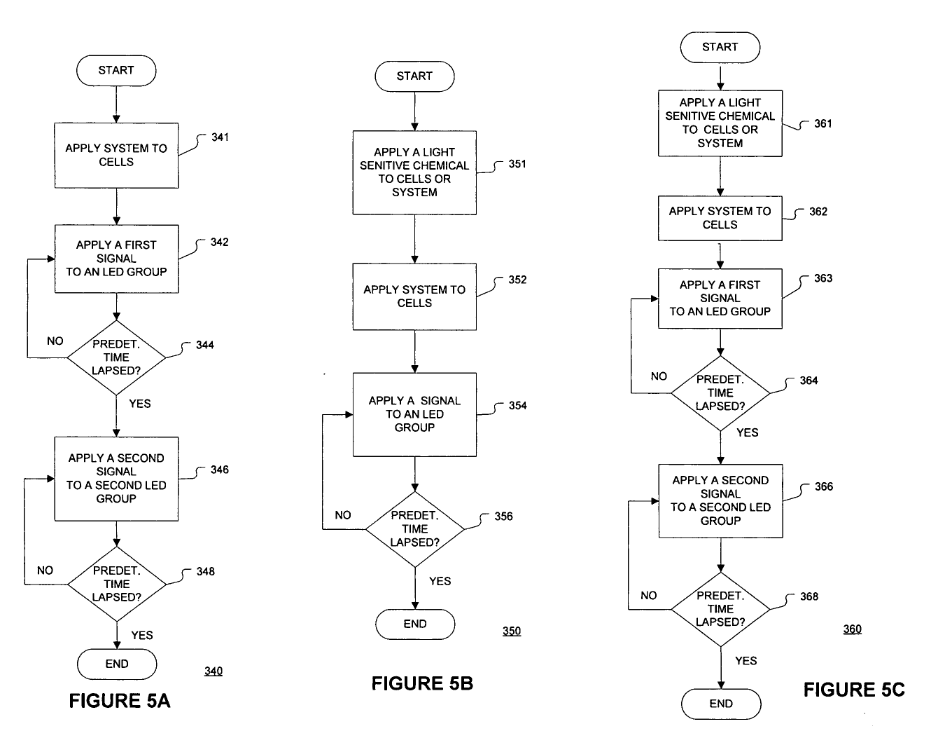

In an embodiment the invention may employ the algorithm 340 shown in FIG. 5A to apply therapy to teeth and related gum cells. A user, clinician, or equipment may place a system 10, 100, 200, 210 on teeth and related gum cells to be treated (activity 341). A first signal such as shown in FIGS. 3A, 3B, and 4 may be applied to a first LED module or group (32A) of a teeth and related gum system 10 (activity 342) for a predetermined time period (activity 344). A second signal such as shown in FIGS. 3A, 3B, and 4 may be applied to a second LED module or group (32B) of a teeth and related gum system 10 (activity 346) for a predetermined time period (activity 348). The signals applied to the groups may be selected to stimulate teeth and related gum cells or chemicals 22A.

In another embodiment the invention may employ the algorithm 350 shown in FIG. 5B to apply therapy to teeth and related gum cells. A user, clinician, or equipment may apply a light sensitive chemical on a system 10 or on teeth and related gum cells to be treated (activity 351). The user, clinician, or equipment may place a system 10 on teeth and related gum cells to be treated (activity 352). A signal such as shown in FIGS. 3A, 3B, and 4 may be applied to a LED module or group (32A or 32B) of a teeth and related gum system 10 (activity 354) for a predetermined time period (activity 356).

In another embodiment the invention may employ the algorithm 360 shown in FIG. 5C to apply therapy to teeth and related gum cells. A user, clinician, or equipment may apply a light sensitive chemical on a system 10 or on teeth and related gum cells to be treated (activity 361). The user, clinician, or equipment may place a system 10 on teeth and related gum cells to be treated (activity 362). A first signal such as shown in FIGS. 3A, 3B, and 4 may be applied to a first LED module or group (32A) of a teeth and related gum system 10 (activity 363) for a predetermined time period (activity 364). A second signal such as shown in FIGS. 3A, 3B, and 4 may be applied to a second LED module or group (32B) of a teeth and related gum system 10 (activity 366) for a predetermined time period (activity 368).

The systems 10 may be used to employ cosmetic or medications or other chemicals directly on teeth and related gum cells with the addition of light of specific frequencies for treatment and healing of cells of tissue with the object of assisting the agents used in delivery, uptake, action and function more effectively. The LEDs 32A, 32B may create the specific frequencies of light. The system 10 light application may enable cosmetic or medication or other active chemicals 22A on teeth and related gum cells for longer time periods while preventing dehydration of the applied substances. Such light application may improve the efficacy of cosmetic or medication or other active chemical as a function of the selected wavelengths or frequencies.

Further the teeth and related gum system application may increase cellular activity and help heal tissue faster and facilitate the delivery, uptake and use in the cell of the cosmetics, medications, or chemicals 22A used. The LED light of specific frequencies can increase fibroblast production and collagen as well as other activities of the cell including stimulating the organelles and mitochondria to produce ATP for cell energy for functioning, decreasing treatment time and facilitate healing. The system 10 make the agents used on the body more efficacious and useful to the body on a cellular level.

The system 10, 100, 200, 210, 300 may include a semi permanent flexible body masking for a teeth and related gum area to stop dehydration and maintain the proper dosage or amount of cosmetic, medication or other chemicals to affect the cells of the body while allowing exposure of the selected teeth and related gum cells to actinic light from LED or other actinic light source. It is noted that the chemical 22A may include a photo reactive substance such as a silver ion, PDT drugs, beta-carotenes, pigments or any other photo reactive substance that may increase energy states of molecules and/or an increase in the efficacy and reaction of the cells of the body when using LED or other light of certain wavelengths activate the substance that is kept on the body via the system 10, 100, 200, 210, 300 containing one or more LED's 32A, 32B or other light source. The system 10, 100, 200, 210, 300 may be used with a trans-dermal delivery substance, e.g., the Latitude Pharmaceutical Dermal Delivery System.

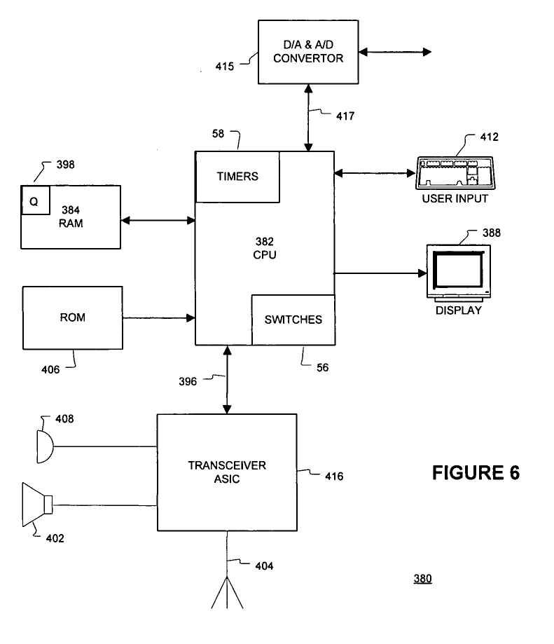

FIG. 6 is a block diagram of an article 380 according to various embodiments. The article 380 shown in FIG. 6 may be used in various embodiments as a part of a system 10 where the article 380 may be any computing device including a personal data assistant, cellular telephone, laptop computer, or desktop computer. The article 380 may include a central processing unit (CPU) 382, a random access memory (RAM) 384, a read only memory (ROM”) 406, a display 388, a user input device 412, a transceiver application specific integrated circuit (ASIC) 416, a digital to analog (D/A) and analog to digital (A/D) convertor 415, a microphone 408, a speaker 402, and an antenna 404. The CPU 382 may include an OS module 414 and an application module 413. The RAM 384 may include switches 56 and timers 58.

The ROM 406 is coupled to the CPU 382 and may store the program instructions to be executed by the CPU 382. The RAM 384 is coupled to the CPU 382 and may store temporary program data, overhead information, and the queues 398. The user input device 412 may comprise an input device such as a keypad, touch pad screen, track ball or other similar input device that allows the user to navigate through menus in order to operate the article 380. The display 388 may be an output device such as a CRT, LCD, LED or other lighting apparatus that enables the user to read, view, or hear user detectable signals.

The microphone 408 and speaker 402 may be incorporated into the device 380. The microphone 408 and speaker 402 may also be separated from the device 380. Received data may be transmitted to the CPU 382 via a bus 396 where the data may include signals for an LED 32A, 32B, 332 or optical module. The transceiver ASIC 416 may include an instruction set necessary to communicate data, screens, or signals. The ASIC 416 may be coupled to the antenna 404 to communicate wireless messages, pages, and signal information within the signal. When a message is received by the transceiver ASIC 416, its corresponding data may be transferred to the CPU 382 via the serial bus 396. The data can include wireless protocol, overhead information, and data to be processed by the device 380 in accordance with the methods described herein.

The D/A and A/D convertor 415 may be coupled to one or more optical modules to generate a signal to be used to energize one of the optical modules. The D/A and A/D convertor 415 may also be coupled to one devices such as LEDs 32A, 32B. Any of the components previously described can be implemented in a number of ways, including embodiments in software. Any of the components previously described can be implemented in a number of ways, including embodiments in software. Thus, the LEDs 32A, 32B, controllers 54, switch 56, timers 58, controller 320 may all be characterized as “modules” herein. The modules may include hardware circuitry, single or multi-processor circuits, memory circuits, software program modules and objects, firmware, and combinations thereof, as desired by the architect of the system 10, 30, 50, 60 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived there-from, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A method of treating teeth and related gum tissue, comprising:
placing a flexible translucent material including at least malleable material on a first and a second surface therein on or near teeth and related gum tissue to be treated;
creating an impression of at least one tooth in the at least malleable material on the first surface; and
creating an impression of at least one tooth in the at least malleable material on the second surface.

2. The method of claim 1, further comprising placing a chemical one of on and within at least a portion of the at least malleable material on the first surface.

3. The method of claim 1, further comprising placing a chemical one of on and within at least a portion of the at least malleable material on the first surface.

4. The method of claim 2, wherein the chemical is a photoactive chemical.

5. The method of claim 1, comprising placing a flexible translucent material including at least one embedded LED therein on or near the at least malleable material; and energizing the LED.

6. The method of claim 5, comprising generating an infra-red signal toward teeth and related gum tissue to be treated.

7. The method of claim 1, embedding at least one LED in the flexible translucent material; and energizing the LED to generate a signal toward teeth and related gum tissue to be treated for a predetermined time interval.

8. The method of claim 7, comprising embedding at least one LED, a power source, and a controller coupling the LED to the battery therein on or near teeth and related gum tissue to be treated in the flexible translucent material; and energizing the LED to generate a signal toward teeth and related gum tissue to be treated for a predetermined time interval.

9. The method of claim 7, comprising placing a reflective layer on an outer surface of the flexible translucent material, the outer surface opposite the inner surface.

10. The method of claim 7, wherein the flexible translucent material is a semi-rigid silicon and the malleable material is a malleable silicon.

11. A apparatus for treating teeth and related gum tissue, comprising:
a flexible translucent material including at least malleable material on a first and a second surface therein on or near teeth and related gum tissue to be treated, the at least malleable material configured to create an impression of at least one tooth in the at least malleable material on the first surface and to create an impression of at least one tooth in the at least malleable material on the second surface.

12. The apparatus for claim 11, further comprising a treatment chemical one of on and within at least a portion of the at least malleable material on the first surface.

13. The apparatus for claim 11, further comprising a treatment chemical one of on and within at least a portion of the at least malleable material on the first surface.

14. The apparatus for claim 12, wherein the chemical is a photoactive chemical.

15. The apparatus for claim 11, wherein the flexible translucent material includes at least one embedded LED therein on or near the at least malleable material.

16. The apparatus for claim 15, means for generating an infra-red signal toward teeth and related gum tissue to be treated.

17. The apparatus for claim 11, further including at least one LED in the flexible translucent material and means for energizing the LED to generate a signal toward teeth and related gum tissue to be treated for a predetermined time interval.

18. The apparatus for claim 17, further comprising at least one LED, a power source, and a controller coupling the LED to the battery therein on or near teeth and related gum tissue to be treated embedded in the flexible translucent material; and means for energizing the LED to generate a signal toward teeth and related gum tissue to be treated for a predetermined time interval.

19. The apparatus for claim 17, further comprising a reflective layer on an outer surface of the flexible translucent material, the outer surface opposite the inner surface.

20. The apparatus for claim 17, wherein the flexible translucent material is a semi-rigid silicon and the malleable material is a malleable silicon.
